(19) United States
(12) Patent Application Publication
(10) Pub. No.: US 2008/0118884 A1
(43) Pub. Date: May 22, 2008

(54) DENTAL PUNCH TOOL FOR USE WITH A DENTAL OVERLAY

(76) Inventor: Laurel R. Leslie-Martin, Longmont, CO (US)

Correspondence Address: THE OLLILA LAW GROUP LLC, 2060 BROADWAY, SUITE 300, BOULDER, CO, 80302, US

(21) Appl. No.: 11/562,291

(22) Filed: Nov. 21, 2006

(51) Int. Cl. A61C 7/04

(52) U.S. Cl. 433/4

(57) ABSTRACT

A dental punch tool for use with a dental overlay is provided according to an embodiment of the invention. The dental punch tool includes a first tool portion including a first jaw portion, a first grip portion, and a first pivot aperture located between the first jaw portion and the first grip portion. The first jaw portion includes an anvil. The dental punch tool further includes a second tool portion including a second jaw portion, a second grip portion, and a second pivot aperture located between the second jaw portion and the second grip portion. The second jaw portion includes an anvil aperture that substantially matches the anvil. The dental punch tool further includes a pivot member that passes through the first and second pivot apertures and pivotally affixes the first tool portion to the second tool portion.

### BACKGROUND OF THE INVENTION

1. Field of the Invention

The present invention relates to a dental punch tool, and more specifically, to a dental punch tool for use with a dental overlay.

2. Statement of the Problem

Orthodontic alignment is a cosmetic procedure that people obtain when they have crooked or misaligned teeth. Orthodontic alignment operates to realign and reposition individual teeth. Individual teeth can be moved up or down, side to side, or in and out with respect to the gums of a patient.

New developments in orthodontic technology include dental overlay devices that fit over existing teeth and exert aligning forces on the teeth. A dental overlay can comprise a device that fits over some or all of the teeth of the patient. A dental overlay can include an aligner device or a retainer device. A series of such aligner devices are used to gradually move the teeth of a patient.

A retainer is a device that is used to either protect teeth or maintain previously aligned teeth in a desired position. After realignment has been achieved, a retainer is commonly employed to keep a patient's teeth in a desired alignment.

An aligner or retainer is typically created by taking an impression of the subject's teeth. The impression is used to cast a mold of the subject's teeth. The mold is then used to form the aligner or retainer. The aligner or retainer can be formed using conventional methods, such as thermoforming, wherein a polymer is heated and correspondingly pulled over the cast of the patient's teeth until the material matches the size and placement of the patient's teeth. The formed aligner or retainer shell fits substantially over the patient's existing teeth. Some companies manufacture a series of aligners to move the teeth. As deemed necessary, inward bumps or dimples can be formed in the aligner shell. The bumps or dimples exert forces at specific points on the teeth in order to move the teeth. Inward bumps or dimples (i.e., projections that extend towards the teeth) can be placed in the aligner to exert forces at specific points on the teeth in order to move the teeth. As a result the completed aligner does not fit passively over the existing teeth, but has to be installed with some force.

On occasion, it is necessary to cut out a portion of an edge of a dental overlay. For example, additional brackets may be affixed to specific teeth in order to generate extra (or larger) forces on certain teeth or to act as an anchorage unit, and the aligner or retainer must be notched or otherwise cut out in order to accommodate the brackets. In addition, force creating elements may be affixed to projections of the aligner or retainer created by two adjacent notches or cut-outs, e.g., elastics.

In the prior art, when a dental overlay needs to be notched out for the installation of brackets, etc., a notch must be formed by hand with scissors or other cutting tools. Alternatively, some manner of prior art punch designed for other uses can be employed, although it is not recommended for reasons of non-sterility and lack of adaptation. However, the result is often a notch that is inappropriately sized, irregular in shape, and has substantially irregular edges. The irregular edges can chafe or abrade the gums of the wearer, leading to discomfort, pain and swelling, and even to infection or other complications.

### SUMMARY OF THE SOLUTION

A dental punch tool for use with a dental overlay is provided according to an embodiment of the invention. The dental punch tool comprises a first tool portion including a first jaw portion, a first grip portion, and a first pivot aperture located between the first jaw portion and the first grip portion. The first jaw portion includes an anvil. The dental punch tool further comprises a second tool portion including a second jaw portion, a second grip portion, and a second pivot aperture located between the second jaw portion and the second grip portion. The second jaw portion includes an anvil aperture that substantially matches the anvil. The dental punch tool further comprises a pivot member that passes through the first and second pivot apertures and pivotally affixes the first tool portion to the second tool portion.

A dental punch tool for use with a dental overlay is provided according to an embodiment of the invention. The dental punch tool comprises a first tool portion including a first jaw portion a first grip portion, and a first pivot aperture located between the first jaw portion and the first grip portion. The first jaw portion includes a first socket. The dental punch tool further comprises a removable anvil insert including an anvil, with the anvil insert being configured to fit into the first socket, and a second tool portion including a second jaw portion, a second grip portion, and a second pivot aperture located between the second jaw portion and the second grip portion. The second jaw portion includes a second socket. The dental punch tool further comprises a removable aperture insert including an anvil aperture that substantially matches the anvil. The aperture insert is configured to fit into the second socket. The dental punch tool further comprises a pivot member that passes through the first and second pivot apertures and pivotally affixes the first tool portion to the second tool portion.

A dental punch tool for use with a dental overlay is provided according to an embodiment of the invention. The dental punch tool comprises a first tool portion including a first jaw portion, a first grip portion, and a first pivot aperture located between the first jaw portion and the first grip portion. The first jaw portion includes an anvil. The dental punch tool further comprises a second tool portion including a second jaw portion, a second grip portion, and a second pivot aperture located between the second jaw portion and the second grip portion. The second jaw portion includes an anvil aperture that substantially matches the anvil. The dental punch tool further comprises a pivot member that passes through the first and second pivot apertures and pivotally affixes the first tool portion to the second tool portion and a biasing member positioned between the first tool portion and the second tool portion. The biasing member is operable to move the first jaw portion and the second jaw portion apart in an absence of a compression force on the first and second grip portions.

### DESCRIPTION OF THE DRAWINGS

The same reference number represents the same element on all drawings. It should be understood that the drawings are not necessarily to scale.

FIG. 1 shows a dental punch tool according to an embodiment of the invention.

FIG. 2 shows the dental punch tool in use with a dental overlay according to an embodiment of the invention.

FIG. 3 shows a dental overlay.

FIG. 4 shows a portion of the dental overlay including a notch according to an embodiment of the invention.

FIG. 5 shows a portion of the dental overlay including a pair of notches according to an embodiment of the invention.

FIGS. 6A-6H show various anvil shapes according to an embodiment of the invention.

FIG. 7 shows a portion of the dental overlay including an opening according to an embodiment of the invention.

FIG. 8 shows the dental punch tool according to an embodiment of the invention.

FIG. 9 shows a removable aperture insert and a removable anvil insert according to an embodiment of the invention.

FIG. 10 shows the dental punch tool according to an embodiment of the invention.

### DETAILED DESCRIPTION OF THE INVENTION

The present application claims benefit of U.S. provisional patent application 60/815,121, entitled “Punch tool/plier for dental overlay,” filed on Jun. 20, 2006. The provisional is herein incorporated by reference.

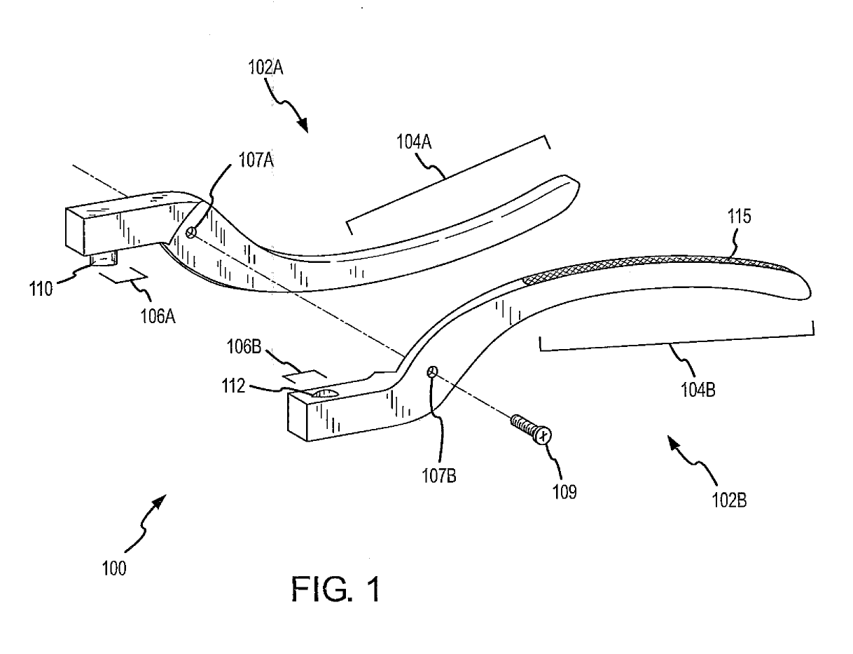

FIGS. 1-10 And the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result the invention is not limited to the specific examples described below, but only by the claims and their equivalents.

FIG. 1 shows a dental punch tool 100 according to an embodiment of the invention. The dental punch tool 100 comprises a first tool portion 102A, a second tool portion 102B, and a pivot pin 109. The pivot pin 109 pivotally attaches the first tool portion 102A to the second tool portion 102B. The pivot pin 109 includes heads (only one is shown) that retain the pivot pin 109 in pivot apertures 107A and 107B in the respective tool portions 102A and 102B.

The first and second grip portions 104A and 104B are designed to be gripped and squeezed. A compression force on the grip portions 104A and 104B places a closing force on the first and second jaw portions 106A and 106B. Due to the longer length of the grip portions 104A and 104B compared to the jaw portions 106A and 106B, the closing force is greater than the compression force on the grip portions 104A and 104B. This force multiplication enables a user to punch through various materials and through various thicknesses of materials.

The first and second grip portions 104A and 104B can include some manner of friction surface 115, as shown, to increase a friction between a user's hand and the dental punch tool 100. Alternatively, any other manner of grooving, cross-hatching, roughening, etc., may be used to improve a user's grip on the dental punch tool 100.

The second tool portion 102B includes an anvil aperture 112 located on the second jaw portion 106B. The anvil aperture 112 passes at least partially through the second jaw portion 106B. Therefore, the anvil aperture 112 can pass entirely through the second jaw portion 106B (shown), or can comprise a blind aperture.

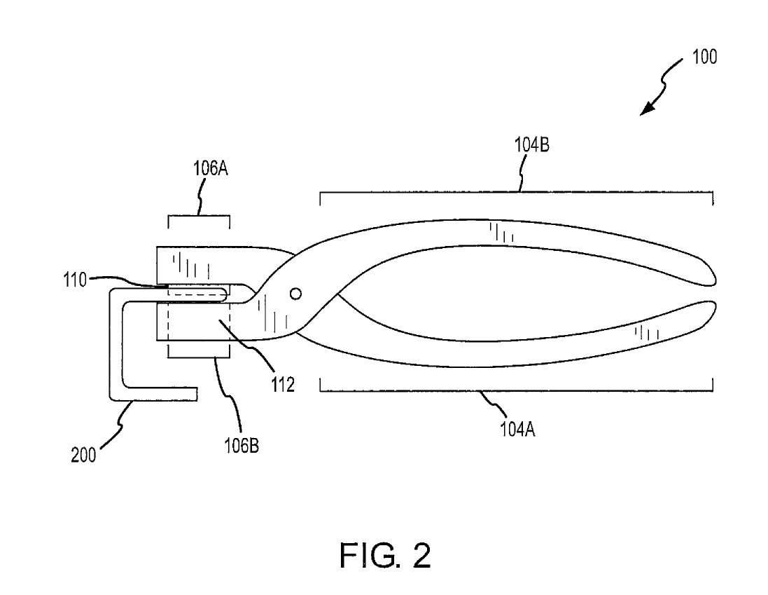

The first tool portion 102A includes a corresponding anvil 110 on the first jaw portion 106A. The anvil 110 fits substantially closely into the anvil aperture 112 and the clearance between the anvil 110 and the anvil aperture 112 is minimal, wherein the edges of the anvil 110 cooperate with the edges of the anvil aperture 112. As a result, the edges perform a cutting/punching function. Consequently, in use, when the two jaws are brought together, the anvil 110 punches out a portion of a dental overlay 200 between the two components (see FIG. 2).

The punched out portion can extend into the dental overlay 200. As a result, the dental punch tool 100 can punch a notch into an edge or margin of the dental overlay 200. Alternatively, the punched out portion can be entirely in the dental overlay 200. As a result, the dental punch tool 100 can punch a complete opening 209 in the dental overlay 200 (see FIG. 7). The opening 209 can comprise any shape. The opening 209 can comprise a decorative shape.

In some embodiments, the sidewalls of one or both of the anvil 110 and the anvil aperture 112 are substantially perpendicular sidewalls. Alternatively, the sidewalls of one or both can be angled. In some embodiments, the edges of one or both of the anvil 110 and the anvil aperture 112 are substantially sharp edges.

The anvil 110 and the anvil aperture 112 can be of any desired width or length. A variety of punches 100 can be produced in sizes corresponding to available dental brackets or other appliances.

FIG. 2 shows the dental punch tool 100 in use with a dental overlay 200 according to an embodiment of the invention. In this figure, the dental punch tool 100 is being used to punch out a portion of an edge of the dental overlay 200. The jaw portions 106A and 106B have been slid over the portion of the dental overlay 200. The grip portions 104A and 104B are then squeezed by the user, bringing the jaw portions 106A and 106B together. Consequently, the anvil 110 forces a correspondingly shaped portion of the dental overlay 200 into the anvil aperture 112 and shears the material. The result is a notch or cut-out of the same shape as the anvil 110.

In the figure, the anvil 110 has pressed partially through the material of the dental overlay 200. It can be seen from the figure that exertion of more force will result in the anvil 110 punching completely through the overlay material, wherein the punched-out portion in some embodiments will fall through the anvil aperture 112.

In the figure, the anvil 110 and the anvil aperture 112 extend at least a small distance from the edge of the dental overlay 200 in order to notch or punch the dental overlay 200. The length of the anvil 110 can be longer than any possible notch depth, for example, and therefore the user can punch the dental overlay 1200 as shallowly or as deeply as desired.

FIG. 3 shows a dental overlay 200. The dental overlay 200 can comprise a dental aligner or retainer, for example. The dental overlay 200 is formed of a size and shape to fit over at least some of the upper or lower teeth of a patient. As a result, the dental overlay 200 can include multiple tooth chambers 202.

The dental overlay 200 is typically formed of a substantially rigid polymer. Consequently, the dental overlay 200 can provide forces to at least some of the underlying teeth.

The dental overlay 200 can comprise either an aligner device, including a clear aligner device, or a retainer device. An aligner device is used to move teeth, i.e., it is an orthodontic appliance. The aligner device can include inward bumps or projections that are formed in the aligner device in order to put predetermined aligning pressures on selected teeth. A retainer device, on the other hand, can comprise a rigid shell that prevents teeth from moving from their current positions.

It is occasionally necessary to notch or cut out the dental overlay 200 in order to make room for other dental or orthodontic devices. It is highly desirable that the notches or cut outs are easily formed. It is highly desirable that the notches or cut outs are quickly and efficiently formed. It is highly desirable that they have smooth and non-jagged edges. It is highly desirable that the punching or cutting process not cause tears or other failures or flaws in the dental overlay 200.

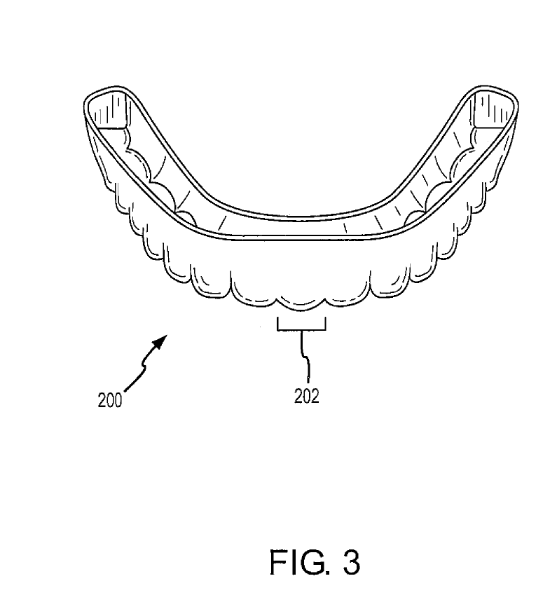

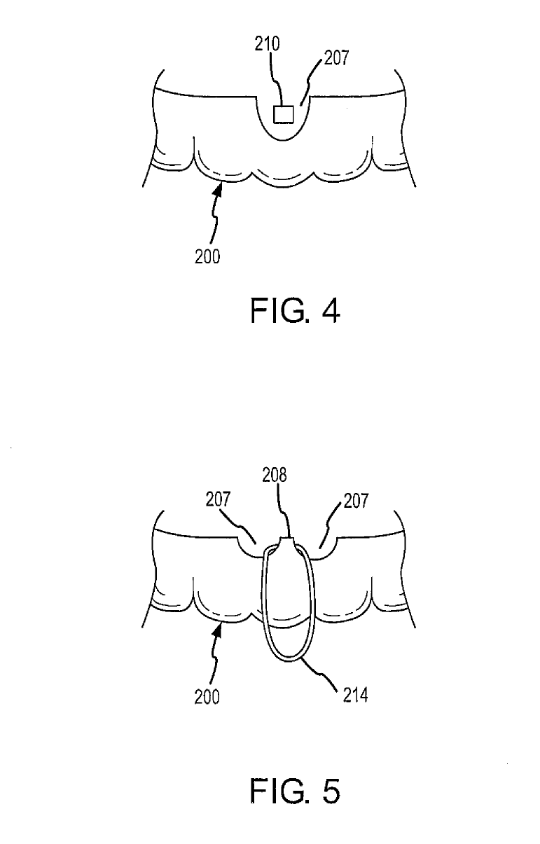

FIG. 4 shows a portion of tie dental overlay 200 including a notch 207 according to an embodiment of the invention. The notch 207 can be of any desired depth. The notch 207 reveals the underlying tooth when the dental overlay 200 is worn by the patient. As a result, a bracket or other dental appliance/dental fixture can be affixed to the underlying tooth, such as by bonding, bands, etc. The bracket 210 can be used for any manner of dental or orthodontic appliance, including portions of braces or other tooth moving devices. The dental overlay 200 can therefore be worn without contacting or otherwise interfering with the bracket 210.

FIG. 5 shows a portion of the dental overlay 200 including a pair of notches 207 according to an embodiment of the invention. The pair of notches 207 form a projection 208, wherein the projection 208 can hold or retain a band 214. The band 214 can comprise an elastic band, for example, that can extend between teeth and can generate forces on the teeth for moving or holding the teeth.

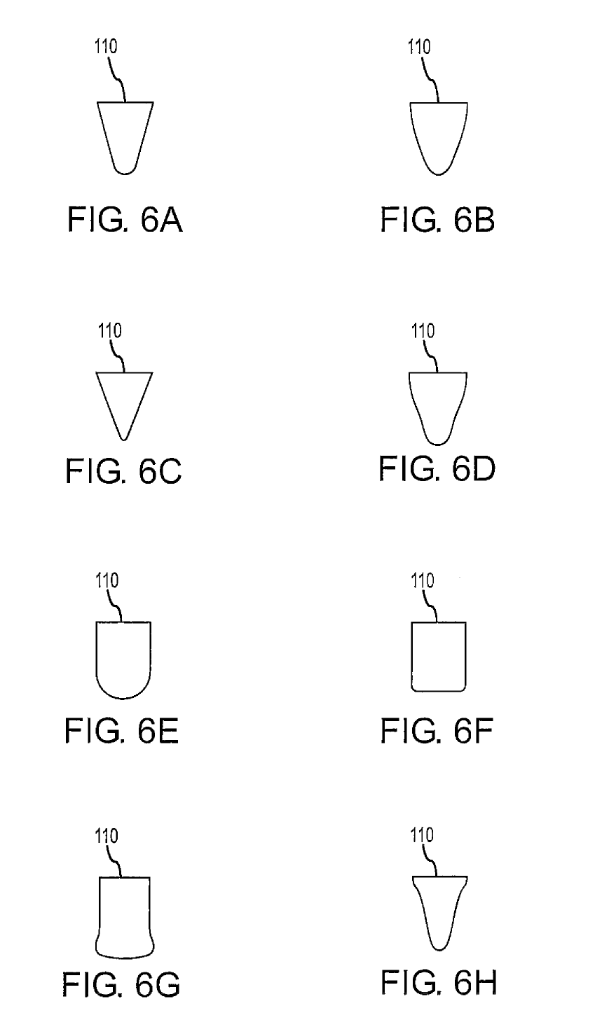

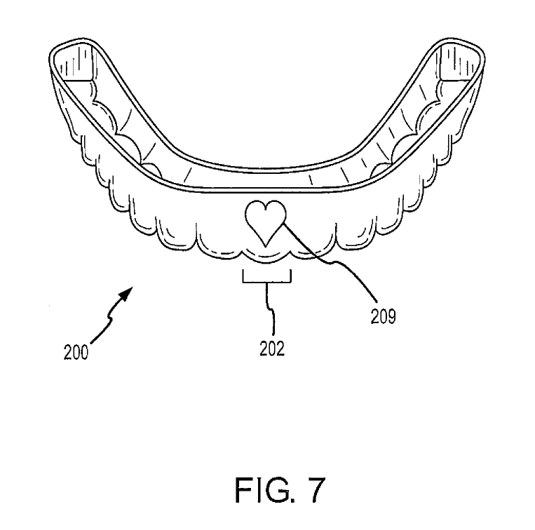

FIGS. 6A-6H show various anvil shapes according to an embodiment of the invention. The anvil 110 can include straight, curved or tapered sides, as shown in the various figures. The anvil 110 can include rounded, blunt, or sharp comers, as shown in the various figures. The sides can be substantially parallel or converging.

The shapes shown and/or described are not exhaustive. Other anvil shapes are contemplated and are within the scope of the description and claims.

FIG. 7 shows a portion of the dental overlay 200 including an opening 209 according to an embodiment of the invention. The opening 209 passes through the shell comprising the dental overlay 200. As previously discussed, the opening 209 can comprise a decorative shape. If the dental overlay 200 is not clear and is not the color of an underlying tooth or teeth, the opening 209 can create a discernable image.

The opening 209 in one embodiment comprises decorative shapes. The decorative shapes can include symbols, logos, alphanumeric characters, etc.

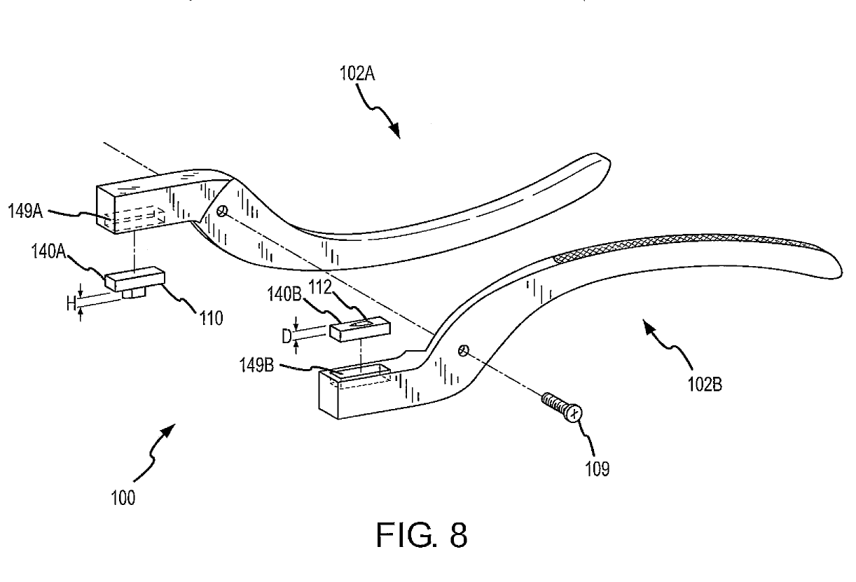

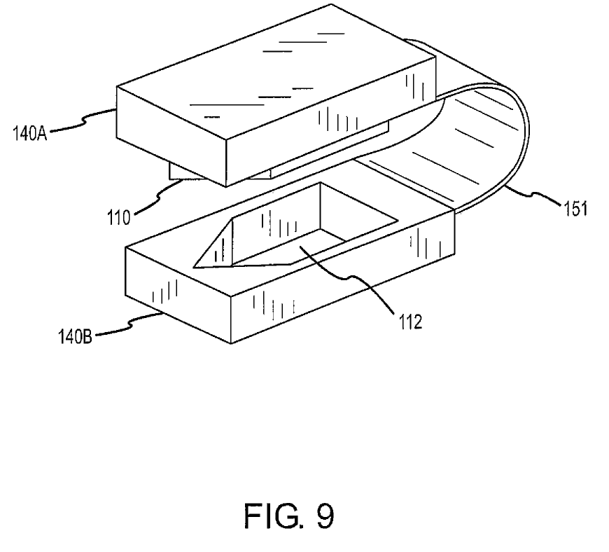

FIG. 8 shows the dental punch tool 100 according to an embodiment of the invention. In this embodiment, the dental punch tool 100 includes an anvil insert 140A and an aperture insert 140B that are received in corresponding sockets 149A and 149B in the first and second tool portions 102A and 102B. The aperture insert 1403 includes the anvil aperture 112 and the anvil insert 140A includes the anvil 110. The anvil 110 and anvil aperture can be of any shape, as previously discussed.

The aperture insert 140B can include an anvil aperture 112 that passes fully through the insert 140B. Alternatively, the anvil aperture 112 of the aperture insert 140B can comprise a blind aperture. In this embodiment, the anvil 110 of the anvil insert 140A is of a smaller height H than the depth D of the anvil aperture 112.

The inserts 140A and 140B are removably held in the sockets 149A and 149B. The dental punch tool 100 can be manufactured with a socket of a predetermined size, and various inserts can be selected and installed into the dental punch tool 100. The removable nature of the inserts 140A and 140B therefore allows an appropriate anvil/anvil aperture set to be selected and installed in the dental punch tool 100. Consequently, the dental punch tool 100 is flexible and configurable. In addition, the dental punch tool 100 can include sockets 149A and 149B that accommodate inserts of different sizes.

The inserts 140A and 140B can be held In the sockets 149A and 149B by any manner of retainer device, including compressible, resilient, or spring-loaded retainer devices. A retainer device can further include detents, fasteners, magnetization, etc. Other retainer devices are contemplated and are within the scope of the description and claims.

FIG. 9 shows the removable anvil insert 140A and the removable aperture insert 14013 according to an embodiment of the invention. In this embodiment, the removable anvil insert 140A and the removable aperture insert 140B include a joiner member 151. The joiner member 151 affixes the anvil insert 140A to the aperture insert 140B. The joiner member 151 therefore keeps the aperture insert 140B from being separated from the anvil insert 140A. For example, the joiner member 151 can comprise any manner of cord, wire, strap, etc.

The joiner member 151 in some embodiments can further comprise a biasing member, such as a spring. The joiner member 151 can consequently place an opening force on the first and second jaw portions 106A and 106B through the removable anvil insert 140A and the removable aperture insert 140B. As a result, the joiner member 151 can tend to return the first and second jaw portions 106A and 106B to an open position when the dental punch tool 100 is released by a user.

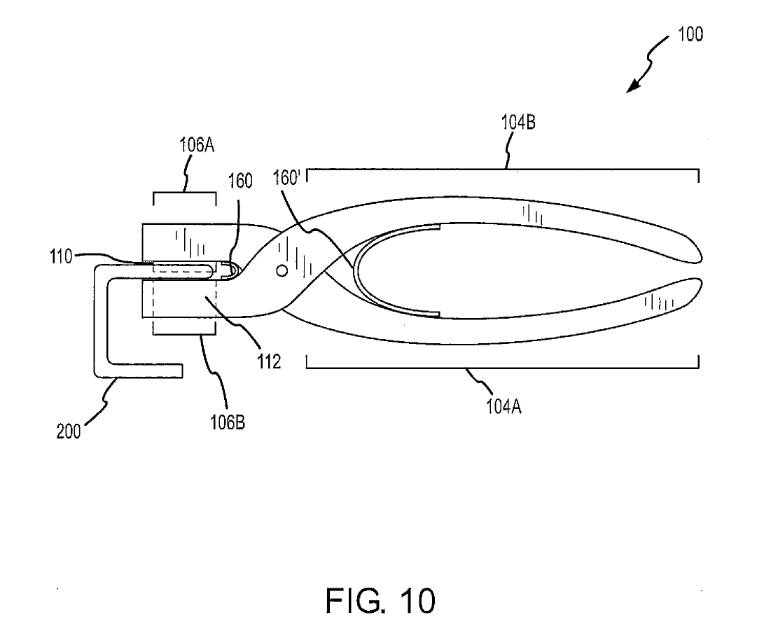

FIG. 10 shows the dental punch tool 100 according to an embodiment of the invention. In this embodiment, the dental punch tool 100 includes a biasing member 160 and/or 160′. The biasing member 160 comprises a biasing member located substantially between the first jaw portion 106A and the second jaw portion 106B. The biasing member 160′ comprises a biasing member located substantially between the first grip portion 104A and the second grip portion 104B. The biasing member 160 or 160′ can be permanently or removably affixed at either location. In either location, the biasing member 160 or 160′ is operable to move the first jaw portion 106A and the second jaw portion 106B apart in an absence of a compression force on the first and second grip portions 104A and 104B.

What is claimed is:

1. A dental punch tool adapted for use with a dental overlay, comprising:
a first tool portion including a first jaw portion, a first grip portion, and a first pivot aperture located between the first jaw portion and the first grip portion, the first jaw portion including an anvil;
a second tool portion including a second jaw portion, a second grip portion, and a second pivot aperture located between the second jaw portion and the second grip portion, the second jaw portion including an anvil aperture that substantially matches the anvil; and
a pivot member that passes through the first and second pivot apertures and pivotally affixes the first tool portion to the second tool portion.

2. The dental punch tool of claim 1, with the anvil aperture passing at least partially through the second jaw portion.

3. The dental punch tool of claim 1, with the anvil aperture passing fully through the second jaw portion.

4. The dental punch tool of claim 1, with the anvil and the anvil aperture comprising a predetermined shape.

5. The dental punch tool of claim 1, with the anvil and the anvil aperture comprising a predetermined decorative shape.

6. The dental punch tool of claim 1, with the anvil and the anvil aperture comprising a predetermined size.

7. The dental punch tool of claim 1, with one or both of the anvil and the anvil aperture including substantially perpendicular sidewalls.

8. The dental punch tool of claim 1, with one or both of the anvil and the anvil aperture including substantially perpendicular sidewalls and substantially sharp edges.

9. The dental punch tool of claim 1, wherein the anvil is formed on an anvil insert and the anvil aperture is formed in an aperture insert, wherein the anvil insert and the aperture insert are removable and interchangeable.

10. The dental punch tool of claim 1, wherein the anvil is formed on an anvil insert and the anvil aperture is formed in an aperture insert, wherein the anvil insert and the aperture insert are removable and interchangeable and wherein the anvil insert and the aperture insert are coupled by a biasing device that provides an opening force to the first and second jaw portions.

11. The dental punch tool of claim 1, further comprising a biasing member positioned between the first tool portion and the second tool portion, with the biasing member being operable to move the first jaw portion and the second jaw portion apart in an absence of a compression force on the first and second grip portions.

12. A dental punch tool adapted for use with a dental overlay, comprising:
a first tool portion including a first jaw portion, a first grip portion, and a first pivot aperture located between the first jaw portion and the first grip portion, the first jaw portion including a first socket;
a removable anvil insert including an anvil, with the anvil insert being configured to fit into the first socket;
a second tool portion including a second jaw portion, a second grip portion, and a second pivot aperture located between the second jaw portion and the second grip portion, the second jaw portion including a second socket;
a removable aperture insert including an anvil aperture that substantially matches the anvil, with the aperture insert being configured to fit into the second socket; and
a pivot member that passes through the first and second pivot apertures and pivotally affixes the first tool portion to the second tool portion.

13. The dental punch tool of claim 12, with the anvil aperture passing at least partially through the second jaw portion.

14. The dental punch tool of claim 12, with the anvil aperture passing fully through the second jaw portion.

15. The dental punch tool of claim 12, with the anvil and the anvil aperture comprising a predetermined shape.

16. The dental punch tool of claim 12, with the anvil and the anvil aperture comprising a predetermined decorative shape.

17. The dental punch tool of claim 12, with the anvil and the anvil aperture comprising a predetermined size.

18. The dental punch tool of claim 12, with one or both of the anvil and the anvil aperture including substantially perpendicular sidewalls.

19. The dental punch tool of claim 12, with one or both of the anvil and the anvil aperture including substantially perpendicular sidewalls and substantially sharp edges.

20. The dental punch tool of claim 12, wherein the anvil insert and the aperture insert are coupled by a biasing device that provides an opening force to the first and second jaw portions.

21. The dental punch tool of claim 12, further comprising a biasing member positioned between the first tool portion and the second tool portion, with the biasing member being operable to move the first jaw portion and the second jaw portion apart in an absence of a compression force on the first and second grip portions.

22. A dental punch tool adapted for use with a dental overlay, comprising:
a first tool portion including a first jaw portion, a first grip portion, and a first pivot aperture located between the first jaw portion and the first grip portion, the first jaw portion including an anvil;
a second tool portion including a second jaw portion, a second grip portion, and a second pivot aperture located between the second jaw portion and the second grip portion, the second jaw portion including an anvil aperture that substantially matches the anvil;
a pivot member that passes through the first and second pivot apertures and pivotally affixes the first tool portion to the second tool portion; and
a biasing member positioned between the first tool portion and the second tool portion, with the biasing member being operable to move the first jaw portion and the second jaw portion apart in an absence of a compression force on the first and second grip portions.

23. The dental punch tool of claim 22, with the anvil aperture passing at least partially through the second jaw portion.

24. The dental punch tool of claim 22, with the anvil aperture passing fully through the second jaw portion.

25. The dental punch tool of claim 22, with the anvil and the anvil aperture comprising a predetermined shape.

26. The dental punch tool of claim 22, with the anvil and the anvil aperture comprising a predetermined decorative shape.

27. The dental punch tool of claim 22, with the anvil and the anvil aperture comprising a predetermined size.

28. The dental punch tool of claim 22, with one or both of the anvil and the anvil aperture including substantially perpendicular sidewalls.

29. The dental punch tool of claim 22, with one or both of the anvil and the anvil aperture including substantially perpendicular sidewalls and substantially sharp edges.

30. The dental punch tool of claim 22, wherein the anvil is formed on an anvil insert and the anvil aperture is formed in an aperture insert, wherein the anvil insert and the aperture insert are removable and interchangeable.

31. The dental punch tool of claim 22, wherein the anvil is formed on an anvil insert and the anvil aperture is formed in an aperture insert, wherein the anvil insert and the aperture insert are removable and interchangeable and wherein the anvil insert and the aperture insert are coupled by a biasing device that provides an opening force to the first and second jaw portions.
